(19) United States
(12) Patent Application Publication
(10) Pub. No.: US 2001/0041555 A1
(43) Pub. Date: Nov. 15, 2001

(54) Method for setting up and charging a telecommunication connection

(76) Inventor: Manfred Lilge, Berlin (DE)

Correspondence Address: William E. Vaughan, Bell, Boyd & Lloyd LLC, P.O. Box 1135, Chicago, IL, 60690-1135, US

(21) Appl. No.: 09/772,380

(22) Filed: Jan. 29, 2001

(30) Foreign Application Priority Data
Jan. 28, 2000 (DE) 10004742.4

(51) Int. Cl. H04M 11/00

(52) U.S. Cl. 455/406; 455/405; 455/407; 455/408

(57) ABSTRACT

A method for the setup and charge-related billing of a telecommunication connection from a telecommunication line unit of a communication network to a target telecommunication network, wherein the telecommunication connection is charged at a preference charge rate when the target communication line unit belongs to a previously made selection of target telecommunication line units and the telecommunication connection is charged at a charge rate that is more expensive vis-a-vis the preference charge rate when the target telecommunication connection does not belong to the selection. In order to have a flexible method that can be simply adapted to changing conditions, an intelligent network controls the setup of the telecommunication connection and provides bits of information that are necessary for the charge-related billing.

### BACKGROUND OF THE INVENTION

1. Field of the Invention

The present invention relates to a method for the setup and charge-related billing of a telecommunication connection from a telecommunication line unit of a communication network to a target telecommunication line unit. The telecommunication connection either is billed according to a preference charge rate when the target telecommunication line unit belongs to a previously made selection of target telecommunication line units or is billed at a higher charge rate when the target telecommunication line unit does not belong to such selection.

2. Description of the Prior Art

Such a method is described, generally, in the leaflet “Neu: Superguenstig ins Festnetz—Die neuen E-Plus City und Partner & Family” of the company E-Plus Service GmhH Potsdam, September, 1998, in the section “Der Partner & Family Tarif: 5 Nummem—bis zu 67% pro Min. sparen”. A selection of 5 target telecommunication line units allowing a connection at a preference charge rate can thereby be present.

The generally fast developing telecommunication market is characterized by frequent changes. Therefore, the present invention is directed to a flexible method that can be simply adapted to changing conditions and with which telecommunication connections of the aforementioned type can be produced and billed in a charge-related fashion.

### SUMMARY OF THE INVENTION

Accordingly, pursuant to the present invention, the setup of the telecommunication connection is controlled by an intelligent network (IN), and bits of required for the charge-related billing are provided by the intelligent network.

An intelligent network typically contains an intelligent node which monitors and controls the processes in the network. It is possible in a simple way to modify the intelligent network and, therefore, to change the inventive method controlled by the intelligent network by modifying the intelligent node (e.g., changing the software of a computer in the intelligent node). It is also possible to combine the inventive method with methods appertaining to other telecommunication networks which are controlled by intelligent networks. It is thus possible, for example, to combine the inventive method for the setup and charge-related billing of a communication connection with what is referred to as a prepaid method, as is explained below.

Pursuant to the method of the present invention, it can be queried from a data memory allocated to the intelligent network whether the target telecommunication line unit belongs to the selection of target telecommunication line units. Given the inventive method, the bits of information necessary for billing can be acquired by the intelligent network and can be forwarded to a billing unit, which is present in the communication network for billing purposes, after the telecommunication connection has been completed.

This embodiment of the inventive method makes it possible to carry out the charge billing after the end of the telecommunication connection and, at the end of a specific period of time (e.g., at the end of the month), to undertake a total billing of all charges of this period of time. This enables the traditional way of charge billing, wherein an invoice regarding the accumulated charges is respectively prepared at the end of the time period, for example.

In another embodiment of the method of the present invention, a prepaid charge credit, for the charge billing, can be reduced by the intelligent network (IN) by an amount deriving from the duration of the telecommunication connection and the preference charge rate or the charge rate that is more expensive vis-a-vis the preference charge rate. As a result of this type of charge acquisition, the inventive method can be combined with a known prepaid method, for example. Given a prepaid method, a user of a telecommunication line unit can only set up telecommunication connections until a charge credit allocated to him is used up. The principle of such a prepaid method, for example, is described under “Gebuehrenvorauszahlung (Pre-paid Services)” on page 3-63 of the book “Handbuch fuer die Telekommunikation”, publisher Dr. V. Jung, Prof. H. -J. Warnecke; published 1998 in Springer-Verlag Berlin, Heidelberg.

Additional features and advantages of the present invention are described in, and will be apparent from, the Detailed Description of the Preferred Embodiments and the Drawings.

### DESCRIPTION OF THE DRAWINGS

FIG. 1 shows an exemplary embodiment of a communication network for implementing the method of the present invention; and

FIG. 2 shows another exemplary embodiment of a communication network for implementing the method of the present invention.

### DETAILED DESCRIPTION OF THE PREFERRED EMBODIMENTS

The inventive method is represented in the following by using the intelligent network (IN) as an example, as it is described, for example, in the book “Technik der Netze” by Gerd Siegmund, 4^{th} revised and enlarged edition, 1999, published in Huethig Verlag Heidelberg, in chapter 6.4. Such intelligent networks generally have at least one service switching point (SSP) and a service control point (SCP), in particular.

A telecommunication connection is to be set up from a telecommunication line unit 1 of a fixed network to a target telecommunication line unit 2 of either a mobile radio network or a fixed network. The target telecommunication line unit 2 has a telecommunication address “12345”, for example. The telecommunication line unit 1 is registered in the intelligent network for participating in the procedure. Therefore, a selection of target telecommunication line units allocated to the telecommunication line unit 1 are stored in the data memory 3 of the intelligent network. The target telecommunication line unit 2 having the telecommunication address “12345” also belongs to this selection.

At the beginning of setting up a telecommunication connection, the telecommunication line unit 1 sends a message N1 to a switching center 4. The information that the telecommunication line unit 1 is registered in the intelligent network for participating in the procedure is contained in a data set DS contained in the switching center 4. The switching center 4, therefore, sends a message N2 to a service switching point SSP of the intelligent network IN. The service switching point SSP subsequently sends a message N3 to a service control point SCP. This message N3 contains the telecommunication address “12345” of the target telecommunication line unit 2. For example, the message IDP (Initial Detection Point) can be sent as message N3. The service control point SCP, with the aid of a query message 5, now queries the information from the data memory 3 whether the target telecommunication line unit 2 having the telecommunication address “12345” belongs to the selection of target telecommunication line units of the telecommunication line unit 1. The data memory 3 sends a response message 6 back to the service control point SCP and informs it that the target telecommunication line unit 2 belongs to the selection allocated to the telecommunication line unit 1. Subsequently, the service control point SCP sends a connection message CON and a charge message FCI to the service switching point SSP.

Likewise, the later mentioned messages SCI (Send Charging Information) and AC (Apply Charging), the message IDP (Initial Detection Point), the connection message CON (Connect) and the charge message FCI (Furnish Charging Information) are messages or, respectively, operations that are defined in the framework of what is referred to as intelligent network application protocol (INAP). These are described, for example, in the Letters Patent Intelligent Network (IN); Intelligent Network Capability Set 1 (CS 1); Core Intelligent Network Application Protocol (INAP); Part 1: Protocol specification, No. ETS 300374-1 (September, 1994) of the European Standards Institute ETSI.

On the basis of the connection message CON, the service switching point SSP sets up the telecommunication connection between the telecommunication line unit 1 and the target telecommunication line unit 2 via a further switching center 9. On the basis of the charge message FCI, bits of information about the beginning and type of the telecommunication connection are deposited in the service switching point SSP in a charge receipt 10 (what is referred to as a charge ticket), these bits of information being necessary for billing charges. After the telecommunication connection has been completed, the bits of information are deposited in the charge receipt 10 beyond the end of this telecommunication connection as well; the charge receipt 10 is subsequently transmitted to a charge unit 11 of the telecommunication network.

As an alternative to the charge message FCI, the service control point SCP also can send the aforementioned charge message SCI to the service switching point SSP. In this case, the service switching point SSP sends a message N4 to the switching center 4, whereupon it prepares a fee receipt 12 and transmits it to the charge unit 11 after the telecommunication connection has been completed. The charge unit 11 later prepares an invoice, wherein a preference charge rate is applied for the described telecommunication connection on the basis of the bits of information contained in the charge receipt 10 or in the fee receipt 12. The previously described processes for billing the charges belong to a type of charge billing, which is also referred to as “postprocessing”, since the charges are only billed after the telecommunication connection has been completed.

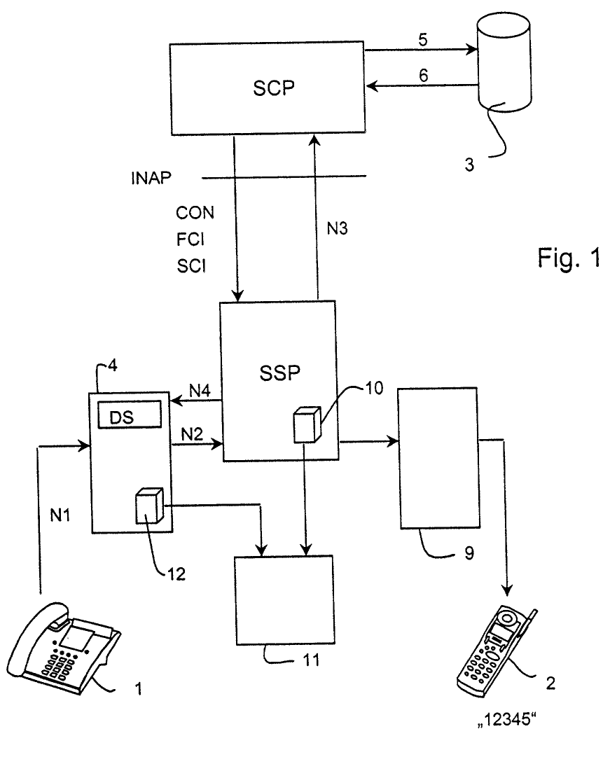

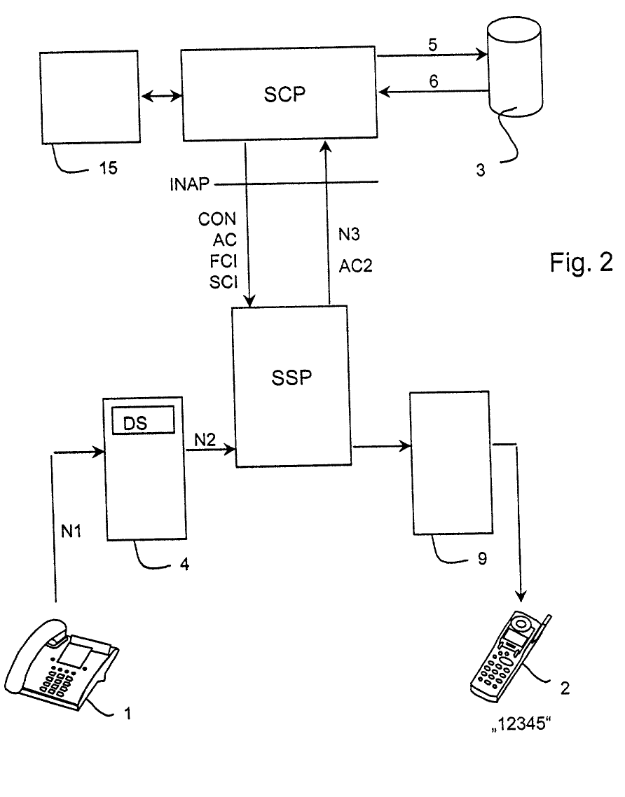

FIG. 2 shows another possibility as to how the telecommunication charges can be billed pursuant to the inventive method. For this purpose, a charge unit 15 is connected to the service control point SCP, and the amount of a prepaid charge credit allocated to the telecommunication line unit 1 is stored in the charge unit 15. The charge unit 15 also can be a part of the service control point SCP or can be formed together with the data memory 3. The method for the setup and charge-related billing of the telecommunication connection occurs in a communication network according to FIG. 2 corresponding to the method described in FIG. 1, wherein the difference is that charge unit 15 queried the amount of the charge credit prior to sending the connection message CON proceeding from the service control point SCP, and the telecommunication connection duration that is maximally possible with the charge credit is determined on the basis of the charge rate to be applied (here, the preference charge rate). The service control point SCP sends this maximally possible telecommunication connection duration to the service switching point SSP via a rate message AC (Apply Charging). The service switching point SSP continuously determines the actual telecommunication connection duration, it interrupts the telecommunication connection after the maximally possible telecommunication connection duration has been reached and it sends the actual telecommunication connection duration back to the service control point SCP via a second rate message AC2 (Apply Charging) after the end of the telecommunication connection. On the basis of the charge rate to be applied (here, the preference charge rate), the service control point SCP determines the accumulated telecommunication charges and correspondingly reduces the amount of the prepaid charge credit allocated to the telecommunication line unit 1. The service control point SCP subsequently initiates that the telecommunication connection is not charged again via a charge receipt 10 (compare FIG. 1) or a fee receipt 12 in that a charge message FCI or charge message SCI containing the charge amount zero is sent. This type of charging is also referred to as “online charging” and makes it possible to utilize the inventive method in connection with the prepaid method, for example.

The previously-described method also can be applied when the telecommunication line unit 1 is a part of a mobile radio network. The information that the telecommunication line unit 1 is registered in the intelligent network for participating in the procedure then can be stored in a data collection O-CSI (Originating CAMEL Subscription Information) in a home file (Home Location Register, HLR) of the mobile radio network given the utilization of the CAMEL standard (Customized Application for Mobile Enhanced Network Logic).

Although the present invention has been described with reference to specific embodiments, those of skill in the art will recognize that changes may be made thereto without departing from the spirit and scope of the invention as set forth in the hereafter appended claims.

I claim as my invention:

1. A method for the setup and charge-related billing of a telecommunication connection from a telecommunication line unit of a communication network to a target telecommunication line unit, the method comprising the steps of:
controlling the setup of the telecommunication connection with an intelligent network;
providing, via the intelligent network, bits of information required for the charge-related billing;
charging the telecommunication connection at a preference charge rate when the target telecommunication line unit belongs to a previously-made selection of target telecommunication line units; and
charging the telecommunication connection at a charge rate that is more expensive than the preference charge rate when the target telecommunication line unit does not belong to the previously-made selection of target telecommunication line units.

2. A method for the setup and charge-related billing of a telecommunication connection from a telecommunication line unit of a communication network to a target telecommunication line unit as claimed in claim 1, the method further comprising the step of:
querying from a data memory allocated to the intelligent network whether the target telecommunication line unit belongs to the selection of target telecommunication line units.

3. A method for the setup and charge-related billing of a telecommunication connection from a telecommunication line unit of a communication network to a target telecommunication line unit as claimed in claim 1, the method further comprising the steps of:
acquiring the bits of information required for the charge-related billing by the intelligent network; and
forwarding the bits of information required for the charge-related billing to a charge unit, which is present in the communication network for the charge billing, after the telecommunication connection has been completed.

4. A method for the setup and charge-related billing of a telecommunication connection from a telecommunication line unit of a communication network to a target telecommunication line unit as claimed in claim 1, the method further comprising the step of:
reducing a prepaid charge credit by the intelligent network by an amount deriving from a duration of the telecommunication connection and one of the preference charge rate and the charge rate that is more expensive than the preference charge rate.
